(19) United States
(12) Patent Application Publication
(10) Pub. No.: US 2025/0022114 A1
(43) Pub. Date: Jan. 16, 2025

(54) CELL SITE EQUIPMENT INSPECTION USING EDGE-BASED IMAGE ANALYSIS

(71) Applicant: International Business Machines Corporation, Armonk, NY (US)

(72) Inventors: UNMESH SATAM, Pune (IN); Jignesh Karia, Thane (IN); HARISH PANI, Bengaluru (IN); ABHISHEK MATHUR, PUNE (IN)

(21) Appl. No.: 18/352,664

(22) Filed: Jul. 14, 2023

(51) Int. Cl. G06T 7/00; B64U 10/13; G06T 7/60; G06T 7/70

(52) U.S. Cl. CPC G06T 7/0002; B64U 10/13; G06T 7/60; G06T 7/70; B64U 2101/26; B64U 2101/30; G06T 2207/10032; G06T 2207/20081; G06T 2207/20084

(57) ABSTRACT

A method is presented including inspecting a cell site, in real-time, with an unmanned aerial vehicle (UAV) including an edge-based artificial intelligence (AI) component mounted thereon, capturing, by one or more cameras of the UAV, a plurality of images pertaining to at least antennae and communication equipment associated with the cell site, identifying, by the AI component, in real-time, the plurality of images to dynamically apply AI inspection models thereto, and generating, in real-time, an inspection report based on information and data derived from applying the AI inspection models to the plurality of images captured.

### BACKGROUND

The present invention relates generally to cell site inspection equipment, and more specifically, to employing an edge-mounted artificial intelligence (AI) solution for cell site inspection.

When a telecommunications operator needs a cell site to be set up, the following process is followed. The installation site is finalized based on market research and customer feedback, a purchase order (PO) is issued to the cell site installation agency, the agency performs physical installation of the contracted equipment at the designated location, and the agency delivers a completion certificate to the telecommunications operator. Then, the operator sends an in-house engineer for cell site inspection. The cell site engineer physically visits the installation site and captures inspection parameters using tools he/she carries with him/her. Parameters can include latitude, longitude, altitude, down tilt, azimuth, and signal strength. These parameters are physically verified against the PO specifications. The process is repeated until the installation parameters meet the agreed upon tolerance criteria. If all is fine, the cell site commissioning certificate is issued.

### SUMMARY

In accordance with an embodiment, a method for is provided. The method includes inspecting a cell site, in real-time, with an unmanned aerial vehicle (UAV) including an edge-based artificial intelligence (AI) component mounted thereon, capturing, by one or more cameras of the UAV, a plurality of images pertaining to at least the antennae and communication equipment associated with the cell site, identifying, by the AI component, in real-time, the plurality of images to dynamically apply AI inspection models thereto, and generating, in real-time, an inspection report based on information and data derived from applying the AI inspection models to the plurality of images captured.

In accordance with another embodiment, a computer program product is provided, the computer program product comprising a computer readable storage medium having program instructions embodied therewith. The program instructions are executable by a computer to cause the computer to inspect a cell site, in real-time, with an unmanned aerial vehicle (UAV) including an edge-based artificial intelligence (AI) component mounted thereon, capture, by one or more cameras of the UAV, a plurality of images pertaining to at least the antennae and communication equipment associated with the cell site, identify, by the AI component, in real-time, the plurality of images to dynamically apply AI inspection models thereto, and generate, in real-time, an inspection report based on information and data derived from applying the AI inspection models to the plurality of images captured.

In accordance with yet another embodiment, a system is provided. The system includes a memory and one or more processors in communication with the memory configured to inspect a cell site, in real-time, with an unmanned aerial vehicle (UAV) including an edge-based artificial intelligence (AI) component mounted thereon, capture, by one or more cameras of the UAV, a plurality of images pertaining to at least the antennae and communication equipment associated with the cell site, identify, by the AI component, in real-time, the plurality of images to dynamically apply AI inspection models thereto, and generate, in real-time, an inspection report based on information and data derived from applying the AI inspection models to the plurality of images captured.

It should be noted that the exemplary embodiments are described with reference to different subject-matters. In particular, some embodiments are described with reference to method type claims whereas other embodiments have been described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered as to be described within this document.

These and other features and advantages will become apparent from the following detailed description of illustrative embodiments thereof, which is to be read in connection with the accompanying drawings.

### BRIEF DESCRIPTION OF THE DRAWINGS

The invention will provide details in the following description of preferred embodiments with reference to the following figures wherein:

FIG. 1 is a block/flow diagram of an exemplary edge-mounted artificial intelligence (AI) solution for inspecting a cell site, in accordance with an embodiment of the present invention;

FIG. 2 is a block/flow diagram of an exemplary method for determining whether an image is real or spoofed, in accordance with an embodiment of the present invention;

FIG. 3 is a block/flow diagram of an exemplary method for validating the elevation of a camera and validating the elevation of cell site equipment, in accordance with an embodiment of the present invention;

FIG. 4 is a block/flow diagram of an exemplary method for validating a down tilt of cell site equipment, in accordance with an embodiment of the present invention;

FIG. 5 is a block/flow diagram of an exemplary method for measuring and validating the azimuth of cell site equipment, in accordance with an embodiment of the present invention;

FIG. 6 is a block/flow diagram of an exemplary method for implementing the edge-mounted AI solution for inspecting the cell site, in accordance with an embodiment of the present invention; and

FIG. 7 is a block diagram of an exemplary computer system for implementing the edge-mounted AI solution for inspecting the cell site, in accordance with an embodiment of the present invention.

Throughout the drawings, same or similar reference numerals represent the same or similar elements.

### DETAILED DESCRIPTION

Embodiments in accordance with the present invention provide methods and systems for employing an edge-mounted artificial intelligence (AI) solution for cell site inspection.

In general, transmission equipment are installed very densely due to scarce real estate on masts or pillars. Often, the masts are reused across 3G/4G equipment and sometimes are shared by multiple operators. Any incorrect configuration directly affects the quality of service, and signal strength, and transmission efficiency of the cell site is thus impacted leading to customer dissatisfaction. Moreover, such cell site work locations are precarious for cell site workers due to, e.g., altitude, difficult site locations, etc. Measurement tools such as an altimeter, azimuth, and GPS locator need to be carried to the cell site location. In case of any observed defects, manual tasks are executed recursively until the desired configuration is achieved. However, capturing measurements through equipment clutter is a challenging task. Signal tests can be performed by using AZQ tools by driving on roads around the cell site location, which is not efficient or productive. The results are captured and then processed at a central location where the certificate of testing is issued. Results are usually entered manually on a handheld device.

The exemplary embodiments of the present invention alleviate such issues by employing an edge-mounted AI solution for cell site inspection where the AI model algorithm checks whether the image is a live image and not a spoofed image. The AI-based model uses the Haversine algorithm to measure a distance between the drone latitude-longitude, and the cell site location coordinates mentioned in the specification to verify that the UAV or drone is flying around the cell tower. The AI-based model further uses front image metadata to determine the image orientation and camera angle. Magnification can be used to determine if the image is captured in the correct horizon angle, and the elevation can be captured by using an onboard sensor (e.g., altimeter). As such, real-time decision making can be performed, by executing the inspection checks, in real-time, at the cell site location by one or more UAVs or drones each mounted with an AI module.

It is to be understood that the present invention will be described in terms of a given illustrative architecture; however, other architectures, structures, substrate materials and process features and steps/blocks can be varied within the scope of the present invention. It should be noted that certain features cannot be shown in all figures for the sake of clarity. This is not intended to be interpreted as a limitation of any particular embodiment, or illustration, or scope of the claims.

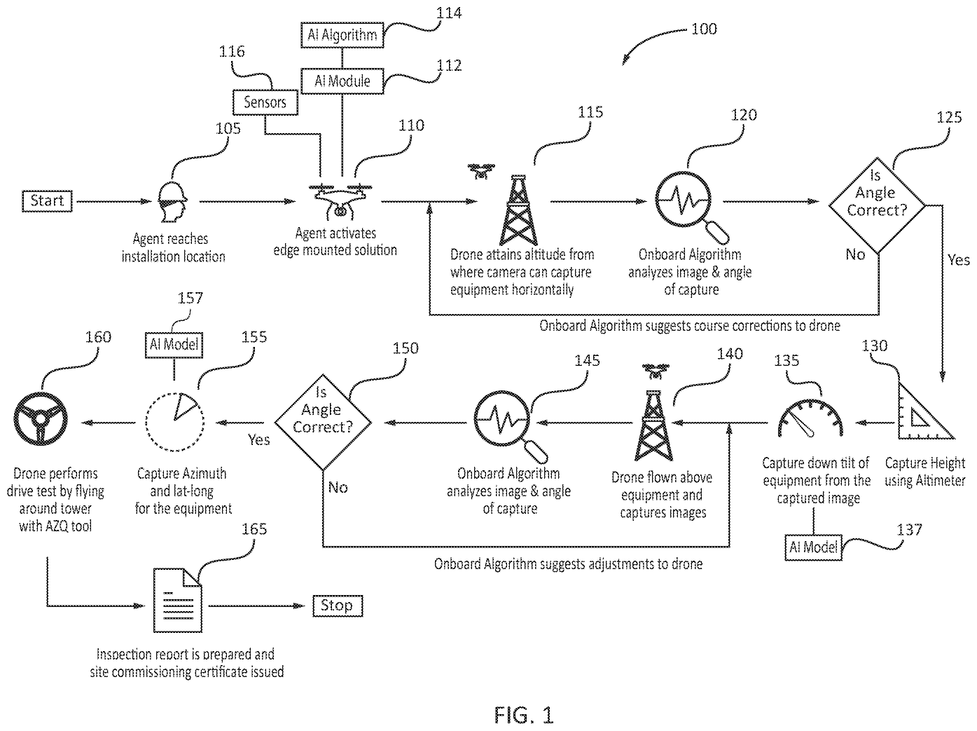

FIG. 1 is a block/flow diagram of an exemplary edge-mounted artificial intelligence (AI) solution for inspecting a cell site, in accordance with an embodiment of the present invention.

Regarding the cell site inspection architecture 100:

At block 105, an agent reaches the installation location. The installation location can be a cell site. A cell site, cell phone tower, or cellular base station is a cellular-enabled mobile device site where antennas and electronic communications equipment are placed (usually on a radio mast, tower, or other raised structure) to create a cell, or adjacent cells, in a cellular network. The agent can be any authorized person. The point is that the inspection can be carried out by any non-experienced cell site inspector as well since the inspection is performed by the AI module.

At block 110, the agent activates an edge-mounted solution, such as an unmanned aerial vehicle (UAV) that flies around the installed equipment. The UAV can be, for example, a drone. The UAV can include a plurality of cameras, as well as a plurality of sensors 116. The UAV can further include an AI module 112 mounted thereon that runs an AI algorithm 114. The AI module 112 can be referred to as an AI component or AI machine or AI device or AI engine. A customized or specialized AI engine or AI component (e.g., 112) can be used to efficiently manage the cell site inspection. The AI machine (e.g., 112) can use neural networks (artificial neural networks) or deep learning techniques.

Artificial neural networks (ANNs) include node layers, containing an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed along to the next layer of the network. Neural networks rely on training data to learn and improve their accuracy over time. However, once these learning algorithms are fine-tuned for accuracy, they are powerful tools, allowing users to classify and cluster data at a high velocity. In the instant case, a cell site AI machine or component or engine or module can employ a cell site neural network having multiple specialized cell site hidden layers configured to optimize cell site inspection techniques.

At block 115, the UAV attains an altitude from where the cameras can capture the equipment horizontally.

At block 120, the onboard AI algorithm analyzes the images and the angle of capture.

At block 125, it is determined whether the angle is correct. If the angle is correct, then the process proceeds to block 130. If the angle is not correct, then the process goes back to block 115. The onboard AI algorithm can suggest course corrections to the UAV.

At block 130, the height is captured by using an altimeter, which determines an altitude attained.

At block 135, the down tilt of the cell site equipment is captured by the cameras of the UAV. The measurement can be made by an AI model 137.

At block 140, the UAV is flown above the equipment to capture further images.

At block 145, the onboard AI algorithm analyzes the images and the angle of capture.

At block 150, it is determined whether the angle is correct. If the angle is correct, then the process proceeds to block 155. If the angle is not correct, then the process goes back to block 140. The onboard AI algorithm can suggest adjustments to the UAV.

At block 155, the azimuth, the latitude, and the longitude, for the cell site equipment is captured by the cameras of the UAV. The measurement can be made by an AI model 157.

At block 160, the UAV performs a drive test by flying around the cell tower with AZQ tools, where AZQ stands for AZENQOS.

At block 165, an inspection report is prepared and a site commissioning certificate is issued.

An unmanned aerial vehicle (UAV) is an aircraft that carries no human pilot or passengers. UAVs, sometimes called drones, can be fully or partially autonomous but are more often controlled remotely by a human pilot. Stated differently, a UAV is defined as a powered, aerial vehicle that does not carry a human operator, uses aerodynamic forces to provide vehicle lift, can fly autonomously or be piloted remotely, can be expendable or recoverable, and can carry a lethal or nonlethal payload. The drone can be either remotely controlled or it can travel as per a predefined path using complex automation algorithms built during its development.

Drones operate at RF frequencies of 2.4 GHz and 5.8 GHz. One of these frequencies is used to control aircraft from the ground system while the other frequency is used to beam or relay video first-person view (FPV). The common frequencies used in FPV video transmission are 900 MHz, 1.2 GHz, 2.4 GHz and 5.8 GHz.

The components of a drone can be as follows:

A drone body that houses a battery power supply, a control system and a plurality of sensors. Gyroscopes and accelerometers are used as sensors in the drone for stabilization purposes. Advanced drone UAVs include cameras and a Wi-Fi transmitter/receiver including a high gain directional antenna.

The drone frame, is made of, e.g., nylon and carbon fiber materials. Due to this fact, the drone is strong and lightweight. The frame is used to hold the shell of the body and frame bars. It also holds the propellers. Landing gear used for landing is mounted at the end of the frame bars.

Propellers are used to produce a force to lift the drone in the air. Propellers are powered by using motors. A total 4 motors are needed for 4 propellers. These motors are powered by using a battery. A total of four propellers are needed, two for clockwise movement and the other two for counter clockwise movement. Of course, one skilled in the art can contemplate a different number of propeller and motors based on application.

The drone further includes a controller having circuitry to control Wi-Fi transmission and reception, circuitry to adjust speed of each propeller and circuitry to have communication with a ground based control system. This is needed to have control of the movement of the drone. The controller part uses a microcontroller and drivers needed to have controlling functionality using remote control or as per a pre-defined route path.

Therefore, in accordance with the exemplary embodiments, real-time decision making is achieved by employing an edge solution for cell tower inspection. An edge-based AI module is mounted on the UAV or drone that captures a plurality of images. The UAV or drone includes a plurality of sensors for conducting various inspection steps. The AI module sends the images to an AI model on the edge that makes immediate, on-the-spot, real-time decisions without any manual assistance. The AI algorithm dynamically measures inspection specifications in real-time. In one instance, the antenna down tilt can be measured in real-time by capturing images from a same height as that of the antenna height captured horizontally. The AI model measures signal strength by using AZQ drive test tools and dynamically measures the distance between the UAV or drone latitude-longitude and the cell site location coordinates. The key benefit is to automate cell tower inspection on cell sites by providing edge-based AI solutions that can conduct real-time inspection without manual assistance. This will advantageously result in reducing the time it takes for manual cell site inspection and provide solutions for worker-related safety incidents while conducting the cell site inspection.

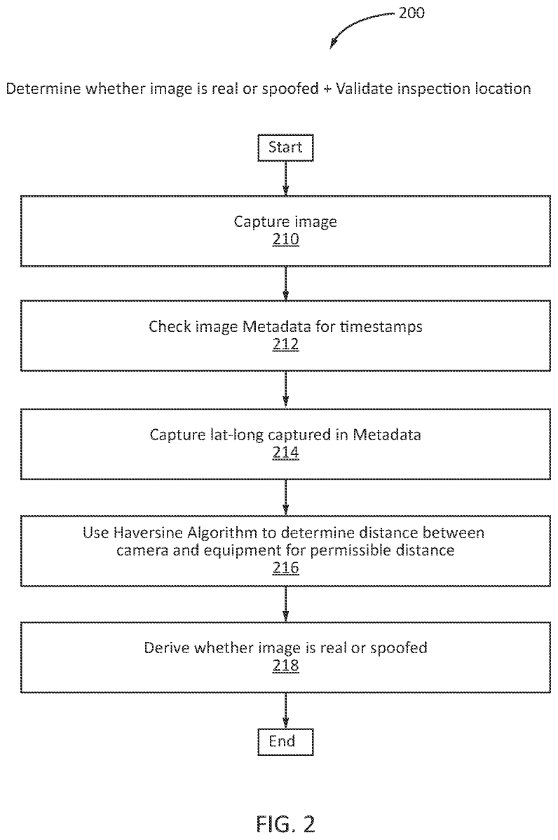

FIG. 2 is a block/flow diagram of an exemplary method for determining whether an image is real or spoofed, in accordance with an embodiment of the present invention.

The exemplary method 200 includes:

At block 210, one or more images are captured.

At block 212, the metadata of the one or more images are checked for time stamps.

At block 214, latitude and longitude information from the metadata is captured.

At block 216, the Haversine algorithm is used to determine a distance between the camera and the equipment for permissible distances.

The Haversine formula determines the great-circle distance between two points on a sphere given their longitudes and latitudes. Important in navigation, it is a special case of a more general formula in spherical trigonometry, the law of haversines, that relates the sides and angles of spherical triangles. Stated differently, the Haversine formula is a very accurate way of computing distances between two points on the surface of a sphere using the latitude and longitude of the two points.

At block 218, it is determined whether the image is real or spoofed.

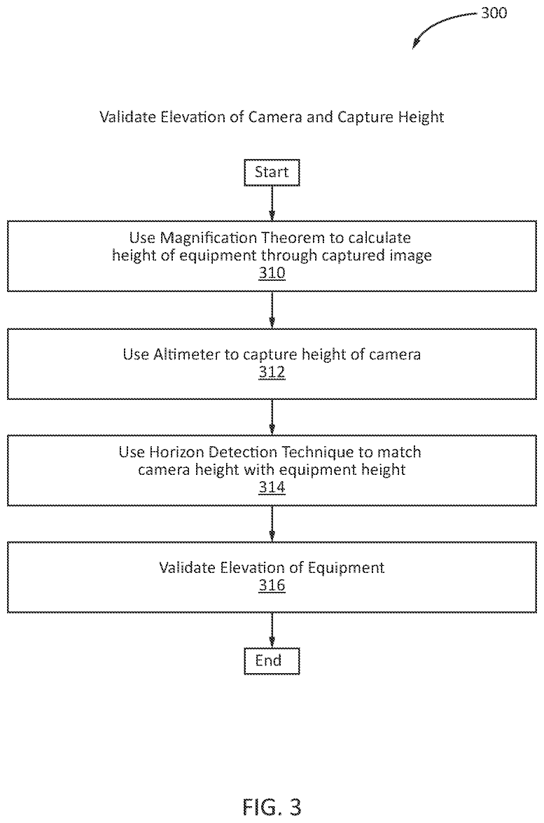

FIG. 3 is a block/flow diagram of an exemplary method for validating the elevation of a camera and validating the elevation of cell site equipment, in accordance with an embodiment of the present invention.

The exemplary method 300 includes:

At block 310, the magnification theorem is used to calculate a height of the equipment from the captured images.

The magnification of an image occurs when the image either appears larger than it actually is or closer than it actually is.

At block 312, the altimeter is used to capture a height of the camera.

At block 314, the horizon detection technique is used to match a camera height with an equipment height.

The horizon detection algorithm attempts to autonomously locate the horizon in an image. If a horizon is present and has been correctly located, it can be used as an aid to autonomous scene interpretation or as an aid to image compression.

At block 316, the elevation of the equipment is validated.

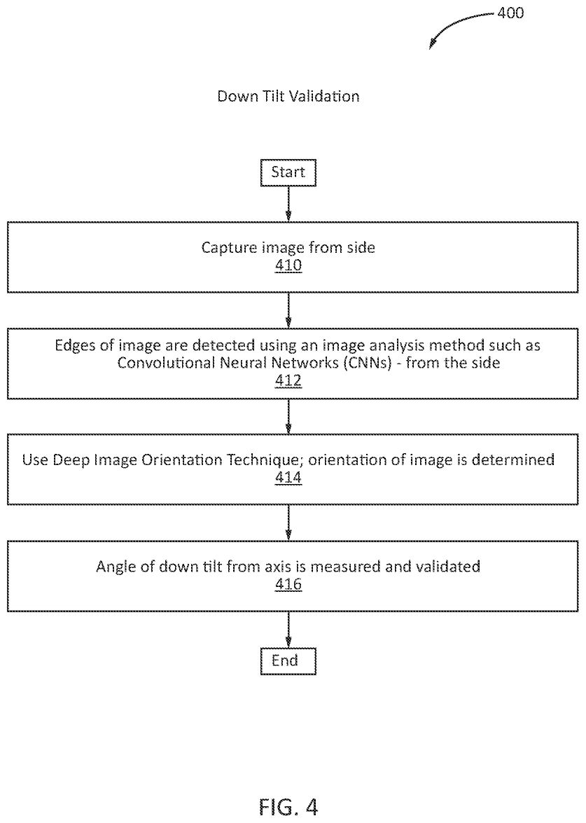

FIG. 4 is a block/flow diagram of an exemplary method for validating a down tilt of cell site equipment, in accordance with an embodiment of the present invention.

The exemplary method 400 includes:

At block 410, the images are captured from the side.

At the block 412, the edges of the images are detected by using an image analysis method involving, e.g., convolutional neural networks (CNNs).

A Convolutional Neural Network (ConvNet/CNN) is a deep learning algorithm that can take in an input image, assign importance (learnable weights and biases) to various aspects/objects in the image, and be able to differentiate one from the other. The pre-processing required in a ConvNet is much lower as compared to other classification algorithms. While in primitive methods filters are hand-engineered, with enough training, ConvNets have the ability to learn these filters/characteristics.

At block 414, deep image orientation techniques are used to determine an orientation of the image.

Image orientation angle detection is a pretty challenging task for a machine, because the machine has to learn the features of an image in such a way so that it can detect the arbitrary angle, the image is rotated. From a human perspective, it is somehow easy to approximately tell the orientation angle of an image based on the elements presented in the image. However, for a machine, an image is just a matrix with pixel values. Thanks to CNNs, it has been possible to build an image orientation angle detection model which predicts the orientation angle accurately.

At block 416, the angle of down tilt from the axis is measured and validated.

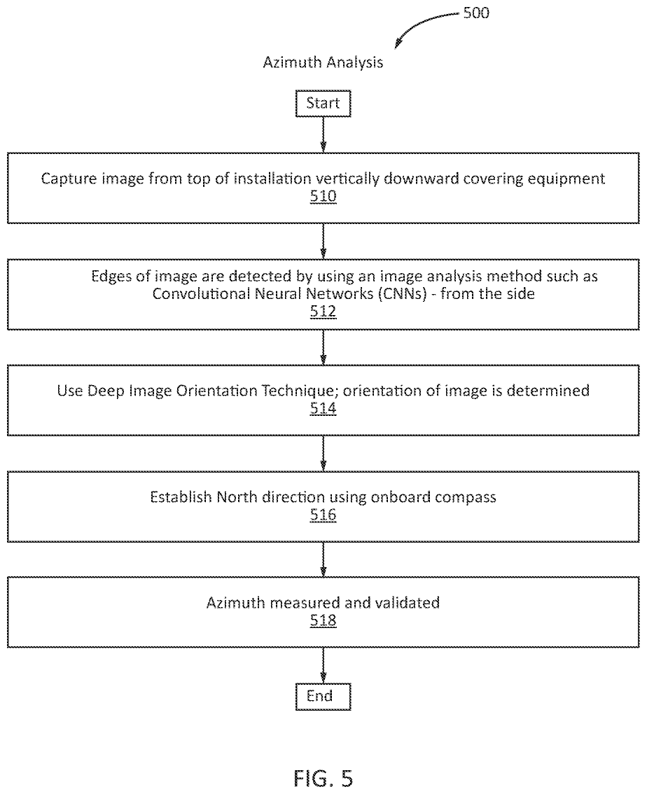

FIG. 5 is a block/flow diagram of an exemplary method for measuring and validating the azimuth of cell site equipment, in accordance with an embodiment of the present invention.

The exemplary method 500 includes:

At block 510, the images are captured from the top of the installation vertically downward (top-down view) to cover all the cell site equipment.

At block 512, the edges of the images are detected by using an image analysis method involving, e.g., CNNs. Of course, one skilled in the art can contemplate using other deep learning algorithms, such as long short term memory networks (LSTMs), recurrent neural networks (RNNs), generative adversarial networks (GANs), multilayer perceptrons (MLPs), self-organizing maps (SOMs), and deep belief networks (DBNs). The deep learning networks can employ specialized algorithms pertaining to cell site inspection techniques.

Image analysis techniques include 2D and 3D object recognition, image segmentation, motion detection, video tracking, optical flow, and 3D pose estimation. One skilled in the art can contemplate employing any type of image analysis techniques to extract image data or information from the cell site towers.

At block 514, deep image orientation techniques are used to determine the orientation of the image.

At block 516, a North direction is established by using an onboard compass.

At block 518, the azimuth is measured and validated.

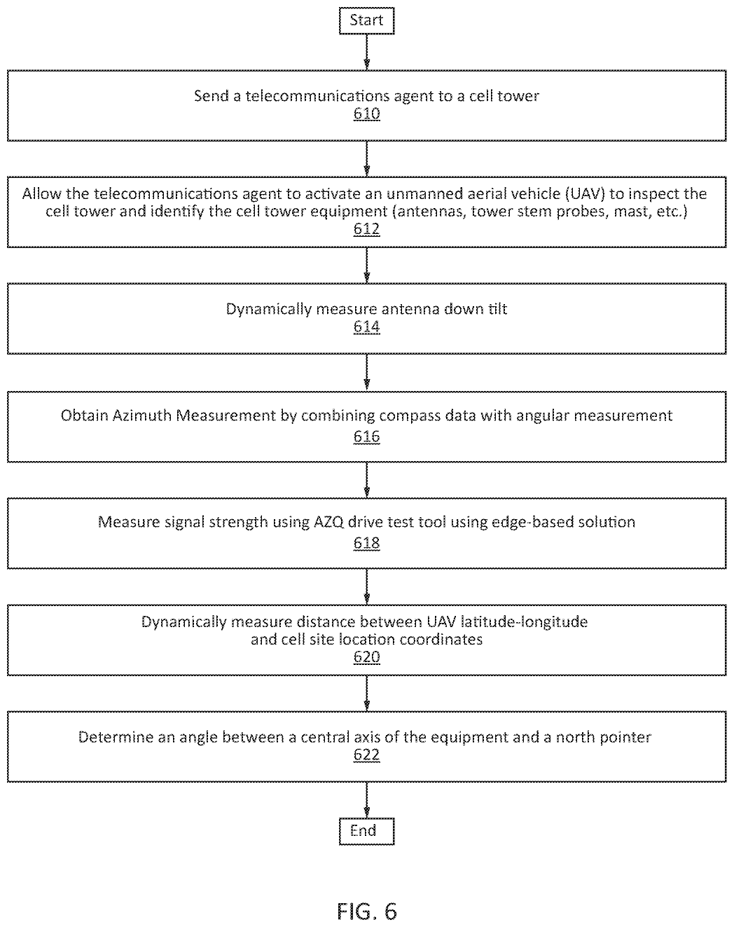

FIG. 6 is a block/flow diagram of an exemplary method for implementing the edge-mounted AI solution for inspecting the cell site, in accordance with an embodiment of the present invention.

At block 610, send a telecommunications agent to a cell tower.

At block 612, allow the telecommunications agent to activate an unmanned aerial vehicle (UAV) to inspect the cell tower and identify cell tower equipment (antennas, tower stem, probes, mast, etc.).

At block 614, dynamically measure antenna down tilt.

At block 616, obtain azimuth measurement by combining compass data with angular measurement.

At block 618, measure signal strength using AZQ drive test tool using edge-based solution.

At block 620, dynamically measure distance between UAV latitude-longitude and cell site location coordinates.

At block 622, determine an angle between a central axis of the equipment and a North pointer.

Therefore, the exemplary method and system dynamically optimizes the process for cell site inspection of the mounted equipment by using an edge-based AI solution. The exemplary method and system distinctly identifies mounted equipment, antennae, tower stem, probes, mast, etc. in order to dynamically apply the relevant inspection cell site AI models. The exemplary method and system uses an AI model to dynamically measure the antenna down tilt by capturing images from the same height as that of the antenna height captured horizontally. The exemplary method and system calculates azimuth measurements by combining compass data with angular measurements using image data from the top of the antennae captured downward (top-down view). The exemplary method and system provides for measuring signal strength using AZQ drive test tools by using the edge-based AI solution. The exemplary method and system further provides for dynamically measuring distance between the UAV or drone latitude-longitude and the cell site location coordinates mentioned in the equipment specifications by using the edge-based AI solution. The exemplary method and system also provides for determining the angle between the central axis of the cell site equipment and the North pointer for analysis.

In conclusion, embodiments in accordance with the present invention provide methods and systems for employing an edge-mounted AI solution for cell site inspection.

Instead of a person inspecting a cell site, it is proposed that an edge-mounted AI solution, such as a UAV or drone be used for inspecting the cell site in real-time.

The UAV or drone is positioned to fly around the cell tower and reach a height of the mounted antenna, as well as other equipment positioned on the inspected object.

The onboard edge-mounted AI solution enables cameras and sensors to capture antenna images from the front and sides of the cell tower, and send such captured images on to a visual analytics AI model hosted locally on the device.

AI-based analytics distinctly identify mounted equipment, antenna, tower stem, probes, mast, etc. to dynamically apply the relevant inspection AI models. This AI model algorithm checks whether the image is a live image and not a spoofed image. The AI-based model uses the Haversine algorithm to measure a distance between the drone latitude-longitude, and the cell site location coordinates mentioned in the specification to verify that the UAV or drone is flying around the cell tower. The permissible distance can be configurable.

The AI-based model uses front image metadata to determine the image orientation and camera angle. Magnification can be used to determine if the image is captured in the correct horizon angle, and the elevation can be captured by using an onboard sensor (e.g., altimeter).

The side image is analyzed to identify a down tilt angle of the mounted equipment from the tower stem. If the angle is not found to be correct, then such observation is registered and reported.

If all the observations in previous steps are completed, the UAV or drone flies above the cell tower such that a top-down view of installation is captured. The next step is to capture the azimuth. The azimuth is a direction of a celestial object from the observer, expressed as the angular distance from the North or South point of the horizon to the point at which a vertical circle passing through the object intersects the horizon.

The UAV or drone uses sensors, such as an onboard compass, and identifies a North direction, which is important for capturing the azimuth.

The camera captures the image from the top-down (or overhead view) view and feeds the same to the onboard AI model. This AI model algorithm checks whether the image is a live image and not a spoofed image. Further, the angle between the central axis of the cell site equipment and the North pointer is measured.

During the whole process, if at any point in time it is observed that the image quality is not good enough for any credible inference (acceptance threshold) then the corresponding images are recaptured by the UAV or drone.

Once the inspection is completed, a processing device mounted on the UAV or drone can be connected to agent's handset/laptop over Bluetooth and the cell site inspection report (based on using the AI mounted module with corresponding AI algorithm) is downloaded.

In an embodiment, a plurality of UAVs or drones can be sent out to a single cell site. The plurality of UAVs or drones can communicate with each other. In other words, all the drones circling the single cell site can send and receive information with respect to each other (e.g., images or video in real-time). Therefore, the cell site inspection report can be generated based on a plurality of UAVs or drones circling or inspecting a single cell site.

In another embodiment, the UAVs or drones can compare the data extracted from one cell site to data extracted from another cell site, in real-time. For instance, a UAV can use data extracted from inspecting a first cell site to the inspection of a second cell site. If the first cell site is adjacent or nearby the second cell site, then if certain inspection issues arose in relation the first cell site, there may be a high probability that such issues also arose at the second cell site. If a storm hit the area where the first and second cells cites are located, then the cell sites may have experience similar issues. The AI module 112 can use that data extracted from the first cell site to build a knowledge corpus or knowledge database that can be used for other cell sites to reduce the inspection time at the other cell sites. The AI module 112 can also provide for comparison data (e.g., images and videos) between cell sites in real-time.

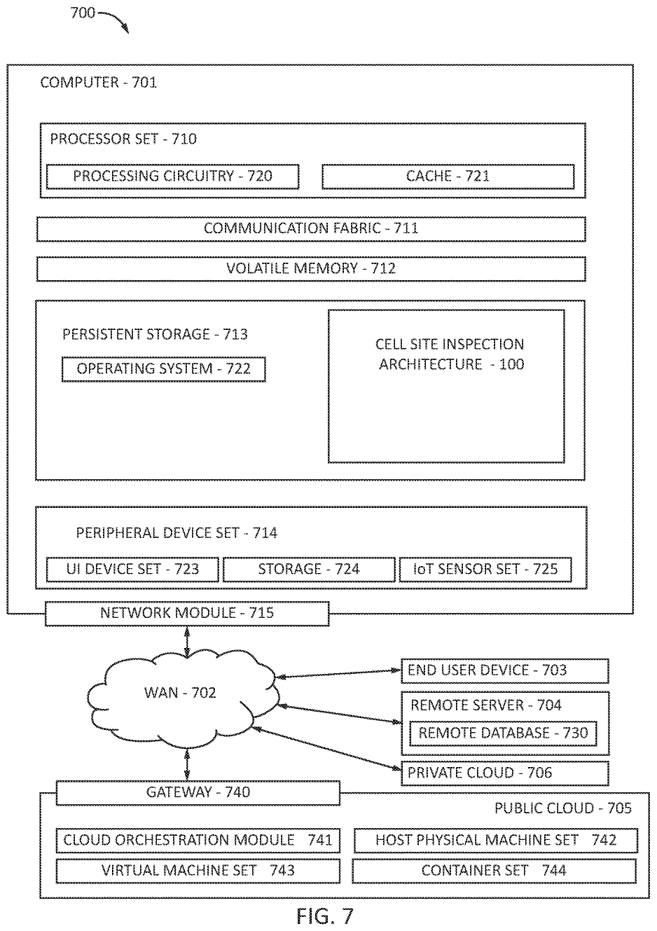

FIG. 7 is a block diagram of an exemplary computer system for implementing the edge-mounted AI solution for inspecting the cell site, in accordance with an embodiment of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is usually moved at some occasional points in time during normal operations of a storage device, such as during access, de-fragmentation or garbage collection, but this does not render the storage device as transitory because the data is not transitory while it is stored.

Computing environment 700 contains an example of an environment for the execution of at least some of the computer code involved in performing the inventive methods, such as the cell site inspection architecture 100. In addition to block 750, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and block 750, as identified above), peripheral device set 714 (including user interface (UI) device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

COMPUTER 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible. Computer 701 may be located in a cloud, even though it is not shown in a cloud in FIG. 7. On the other hand, computer 701 is not required to be in a cloud except to any extent as may be affirmatively indicated.

PROCESSOR SET 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in block 750 in persistent storage 713.

COMMUNICATION FABRIC 711 is the signal conduction path that allows the various components of computer 701 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 712 is any type of volatile memory now known or to be developed in the future. Examples include dynamic type random access memory (RAM) or static type RAM. Typically, volatile memory 712 is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

PERSISTENT STORAGE 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid state storage devices. Operating system 722 may take several forms, such as various known proprietary operating systems or open source Portable Operating System Interface-type operating systems that employ a kernel. The code included in block 750 typically includes at least some of the computer code involved in performing the inventive methods.

PERIPHERAL DEVICE SET 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector.

NETWORK MODULE 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer readable program instructions for performing the inventive methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN 702 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

REMOTE SERVER 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

PUBLIC CLOUD 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It is also noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of methods and devices for employing an edge-mounted AI solution for cell site inspection (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A method comprising:
inspecting a cell site, in real-time, with an unmanned aerial vehicle (UAV) including an edge-based artificial intelligence (AI) component mounted thereon;
capturing, by one or more cameras of the UAV, a plurality of images pertaining to at least antennae and communication equipment associated with the cell site;
identifying, by the AI component, in real-time, the plurality of images to dynamically apply AI inspection models thereto; and
generating, in real-time, an inspection report based on information and data derived from applying the AI inspection models to the plurality of images captured.

2. The method of claim 1, wherein antennae down tilt is measured by capturing a first set of images of the plurality of images from a same height as that of an antenna height captured horizontally.

3. The method of claim 1, wherein azimuth measurements are determined by combining compass data with angular measurements by using a second set of images of the plurality of images captured from a top-down view of the antennae.

4. The method of claim 1, wherein signal strength is measured by using AZQ drive test tools.

5. The method of claim 1, wherein a distance between a latitude and longitude of the UAV, and location coordinates of the cell site are measured by the edge-based AI component.

6. The method of claim 1, wherein an angle between a central axis of the communication equipment associated with the cell site and a North pointer is determined by the edge-based AI component.

7. The method of claim 1, wherein an elevation of the antennae and communication equipment associated with the cell site are continuously validated by employing a magnification theorem.

8. A computer program comprising a computer readable storage medium having program instructions embodied therewith, the program instructions executable by a computer to cause the computer to:
inspect a cell site, in real-time, with an unmanned aerial vehicle (UAV) including an edge-based artificial intelligence (AI) component mounted thereon;
capture, by one or more cameras of the UAV, a plurality of images pertaining to at least antennae and communication equipment associated with the cell site;
identify, by the AI component, in real-time, the plurality of images to dynamically apply AI inspection models thereto; and
generate, in real-time, an inspection report based on information and data derived from applying the AI inspection models to the plurality of images captured.

9. The computer program product of claim 8, wherein antennae down tilt is measured by capturing a first set of images of the plurality of images from a same height as that of an antenna height captured horizontally.

10. The computer program product of claim 8, wherein azimuth measurements are determined by combining compass data with angular measurements by using a second set of images of the plurality of images captured from a top-down view of the antennae.

11. The computer program product of claim 8, wherein signal strength is measured by using AZQ drive test tools.

12. The computer program product of claim 8, wherein a distance between a latitude and longitude of the UAV, and location coordinates of the cell site are measured by the edge-based AI component.

13. The computer program product of claim 8, wherein an angle between a central axis of the communication equipment associated with the cell site and a North pointer is determined by the edge-based AI component.

14. The computer program product of claim 8, wherein an elevation of the antennae and communication equipment associated with the cell site are continuously validated by employing a magnification theorem.

15. A system comprising:
a memory; and
one or more processors in communication with the memory configured to:
inspect a cell site, in real-time, with an unmanned aerial vehicle (UAV) including an edge-based artificial intelligence (AI) component mounted thereon;
capture, by one or more cameras of the UAV, a plurality of images pertaining to at least antennae and communication equipment associated with the cell site;
identify, by the AI component, in real-time, the plurality of images to dynamically apply AI inspection models thereto; and
generate, in real-time, an inspection report based on information and data derived from applying the AI inspection models to the plurality of images captured.

16. The system of claim 15, wherein antennae down tilt is measured by capturing a first set of images of the plurality of images from a same height as that of an antenna height captured horizontally.

17. The system of claim 15, wherein azimuth measurements are determined by combining compass data with angular measurements by using a second set of images of the plurality of images captured from a top-down view of the antennae.

18. The system of claim 15, wherein signal strength is measured by using AZQ drive test tools.

19. The system of claim 15, wherein a distance between a latitude and longitude of the UAV, and location coordinates of the cell site are measured by the edge-based AI component.

20. The system of claim 15, wherein an angle between a central axis of the communication equipment associated with the cell site and a North pointer is determined by the edge-based AI component.
